(19) United States
(12) Patent Application Publication
(10) Pub. No.: US 2011/0216174 A1
(43) Pub. Date: Sep. 8, 2011

(54) METHOD FOR DISPLAYING STEREOSCOPIC IMAGES

(76) Inventors: Mu-Shan Liao, Changhua County (TW); Tung-Hsin Lan, Taipei City (TW); Hung-Chun Li, Taoyuan County (TW)

(21) Appl. No.: 12/772,231

(22) Filed: May 2, 2010

(30) Foreign Application Priority Data
Mar. 3, 2010 (TW) 099106115

(51) Int. Cl. H04N 13/04

(52) U.S. Cl. 348/55; 348/E13.075

(57) ABSTRACT

A stereoscopic image displaying method generates a first and second right-eye multiplexed frame data by respectively performing frequency-multiplexing on a first and second right-eye frame data among a plurality of right-eye frame data, and generates a first and a second left-eye multiplexed frame data by respectively performing frequency-multiplexing on a first and a second left-eye frame data among a plurality of left-eye frame data. The first multiplexed right-eye frame data is outputted for two consecutive times during a first frame period. The first multiplexed left-eye frame data is outputted for two consecutive times during a second frame period subsequent to the first frame period. The second multiplexed right-eye frame data is outputted for two consecutive times during a third frame period subsequent to the second frame period. The second multiplexed left-eye frame data is outputted for two consecutive times during a fourth frame period subsequent to the third frame period.

### BACKGROUND OF THE INVENTION

1. Field of the Invention

The present invention is related to a method for displaying stereoscopic images, and more particularly, to a method for displaying stereoscopic images using an LCD device.

2. Description of the Prior Art

Three-dimensional (3D) stereoscopic display technology provides more vivid visual experiences than traditional two-dimensional (2D) planar display technology. In three-dimensional display technology, right-eye images and left-images are transmitted to left eye and right eye, respectively. Due to different viewing angles of the two eyes, the overlapped right-eye images and left-images in human brain thus create stereoscopic images in human perception. Common methods for displaying stereoscopic images include those using polarizing glasses, shutter glasses and anaglyph. When displaying stereoscopic images using shutter glasses (such as in I-MAX theaters), the left-eye lens and the right-eye lens are alternatively switched on and off: when the right-eye lens is switched on, corresponding right-eye images are simultaneously displayed on the screen; when the left-eye lens is switched on, corresponding left-eye images are simultaneously displayed on the screen. Regardless of the types of display methods, it is required to provide right-eye images and left-eye images, which, although both related to the same image signal, include different depth information.

Among various types of display devices, liquid crystal display (LCD) devices are advantageous in thin appearance, low power consumption and radiation-free. An LCD device displays images having different grayscale values by rotating liquid crystal molecules. The reaction time of liquid crystal molecules is therefore a major factor which influences display quality.

FIG. 1 is a diagram illustrating a prior art LCD device 10 capable of displaying stereoscopic images. The LCD device 10 includes a driving circuit 12 and an LCD panel 14. The driving circuit 12 includes a graphic card 16 providing basic functions which include transmitting/converting image signals (such as receiving, decoding, encoding and outputting frame data), or advanced functions which include 3D stereoscopic image computations, graphic acceleration or multiple output. According to an original image data DATA, the graphic card 16 of the driving circuit 12 generates corresponding left-eye frame data L1-Ln and right-eye frame data R1-Rn, which are then outputted to the LCD panel 14 in the sequence of R1, L1, R2, L2, . . . , Rn and Ln for displaying images.

FIG. 2 is a diagram illustrating a prior art method for driving the LCD device 10 in order to display stereoscopic images. FIG. 2 shows a data driving signal S_{DATA}, a data enable signal S_{ENA}, a left-eye lens-on signal L_{ON}, and a right-eye lens-on signal R_{ON}. The data driving signal S_{DATA} includes n frame data L1-Ln related to the left-eye images and n frame data R1-Rn related to the right-eye images. The data enable signal S_{ENA} includes m frame periods F1-Fm each having a data output interval and a vertical blanking interval. In the prior art method, the frame data R1, L1, R2, L2, . . . , Rn and Ln are sequentially written during the data output intervals D1-Dm of the frame period F1-Fm, respectively; the right-eye lens and the left-eye lens are alternatively switched on/off during the vertical blanking intervals VBI1-VBIm of the frame period F1-Fm, respectively. For example, the first right-eye frame data R1 is written during the data output interval D1 when the right lens and the left lens are both turned off, and then the right-eye lens is turned on during the vertical blanking interval VBI1; the first left-eye frame data L1 is written during the data output interval D2 when the right lens and the left lens are both turned off, and then the left-eye lens during the vertical blanking interval VBI2; . . . ; the same continues for the entire image.

FIG. 3 is a diagram illustrating the operation of the prior art LCD device 10 when displaying stereoscopic images. If the LCD device 10 is scanned in a top-to-bottom direction, TP1, TP2 and TP3 represent the pixel voltages at the test points which are located in upper, central and lower parts of the LCD panel, respectively. L_{ON}/R_{ON} represents the left-eye lens-on signal or the right-eye lens-on signal. During the vertical blanking intervals when the left-eye lens or the right-eye lens is turned on, the levels of the corresponding pixel voltages TP1, TP2 and TP3 are indicated by “”, “♦” and “X” in FIG. 3. As shown in FIG. 3, after being triggered by the start pulse voltage STV at T1, data is first written into the upper part of the LCD panel where the pixels have sufficient reaction time. Therefore, the difference between the pixel voltage TP1 and the target voltage V_{T} is the smallest when the left-eye lens or the right-eye lens is turned on during the vertical blanking intervals. As the LCD panel is scanned from top to bottom, data is then written into the pixels located in the central part of the LCD panel at T2 before written into those located in the lower part of the LCD panel at T3. Since the pixels located in the lower part of the panel have the shortest reaction time, the difference between the pixel voltage TP3 and the target voltage V_{T} is the largest when the left-eye lens or the right-eye lens is turned on during the vertical blanking intervals. As a result, ghosting phenomenon may be present in the prior art LCD device 10, thereby causing poor optical uniformity.

The typical operational frequency of the prior art LCD device 10 when displaying planar images is 60 Hz, which requires a liquid crystal reaction time of about 16.7 ms. However, the operational frequency of the prior art LCD device 10 is doubled to 120 Hz when displaying stereoscopic images, which in turn shortens the liquid crystal reaction time to about 8.3 ms and may influence the display quality due to insufficient charge time. Also, the left-eye lens or the right-eye lens is turned on during the vertical blanking periods in the prior art LCD device 10. Since the length of each vertical blanking period is about ⅓ of a frame period, the charge time of the pixels is further reduced by introducing the vertical blanking periods. On the other hand, the LCD device 10 adopts a linear scan sequence in which each pixel of the LCD panel is scanned in a predetermined direction after being triggered by the start pulse voltage STV. For examples, each row of pixels may be sequentially turned on in the top-to-bottom direction. Since the reaction time of the pixels located at different locations of the LCD panel varies, the prior art LCD device 10 has poor optical uniformity.

### SUMMARY OF THE INVENTION

The present invention provides a method for displaying stereoscopic images comprising generating a plurality of right-eye frame data and a plurality of left-eye frame data according to an original image data; generating a first right-eye multiplexed frame data by performing frequency-multiplexing on a first right-eye frame data among the plurality of right-eye frame data; generating a first left-eye multiplexed frame data by performing frequency-multiplexing on a first left-eye frame data among the plurality of left-eye frame data; outputting the first right-eye multiplexed frame data for two consecutive times during a first frame period; and outputting the first left-eye multiplexed frame data for two consecutive times during a second frame period subsequent to the first frame period.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a prior art LCD device capable of displaying stereoscopic images.

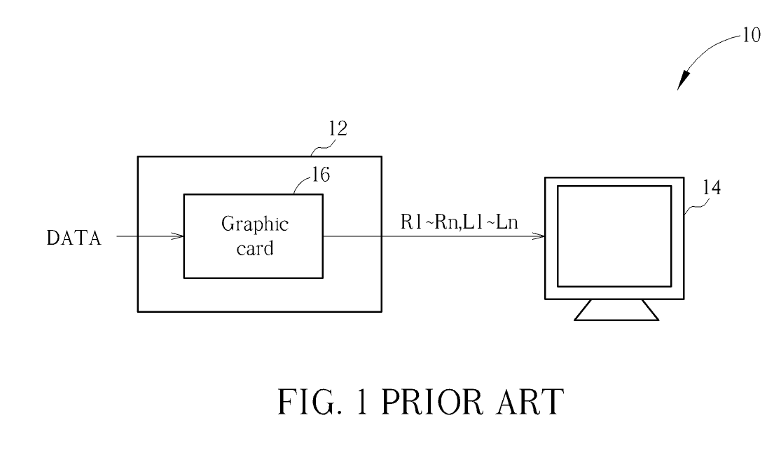

FIG. 2 is a diagram illustrating a prior art method for driving the LCD device in order to display stereoscopic images.

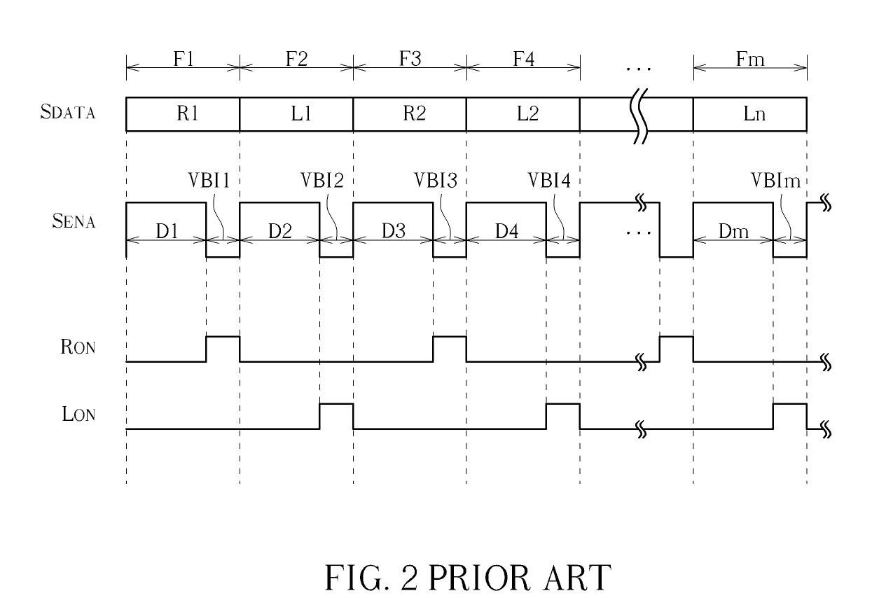

FIG. 3 is a diagram illustrating the operation of the prior art LCD device when displaying stereoscopic images.

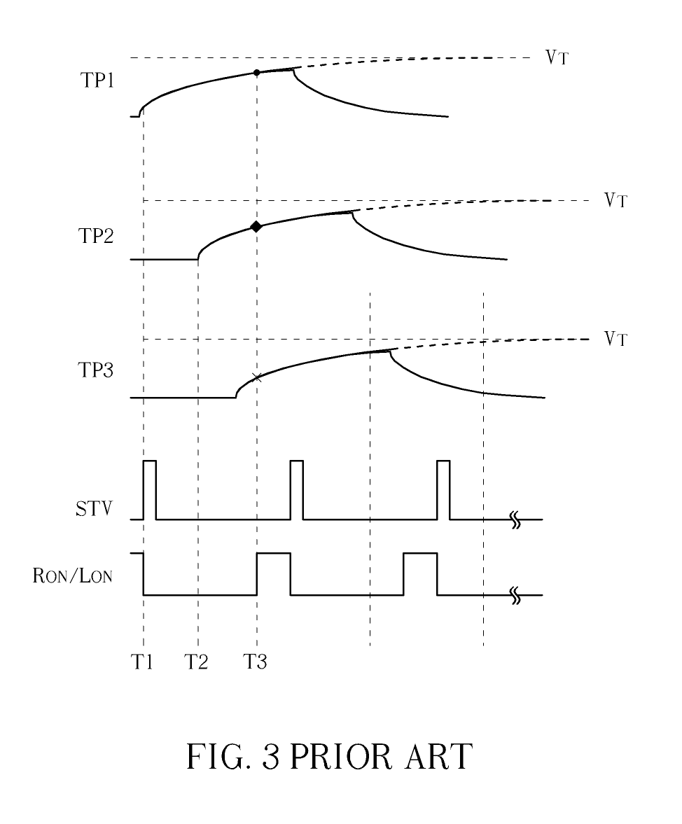

FIG. 4 is a diagram illustrating an LCD device capable of displaying stereoscopic images according to the present invention.

FIG. 5 is a flowchart illustrating the operation of the LCD device in FIG. 4.

FIG. 6 is a diagram illustrating a stereoscopic image display method according to a first embodiment of the present invention.

FIG. 7 is a diagram illustrating a stereoscopic image display method according to a second embodiment of the present invention.

FIG. 8 is a diagram illustrating the operation of the LCD device in FIG. 4.

### DETAILED DESCRIPTION

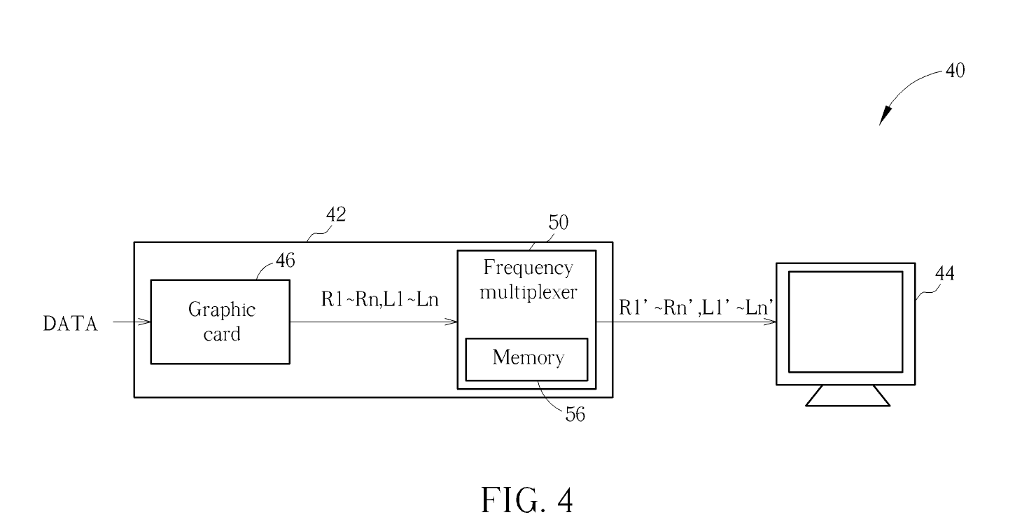

FIG. 4 is a diagram illustrating an LCD device 40 capable of displaying stereoscopic images according to the present invention. The LCD device 40 includes a driving circuit 42 and an LCD panel 44. The driving circuit 42 includes a graphic card 46 and a frequency multiplexer 50. The graphic card 46 may provide basic functions which include transmitting/converting image signals (such as receiving, decoding, encoding and outputting frame data), or advanced functions which include 3D stereoscopic image computations, graphic acceleration or multiple output. The frequency multiplexer 50, including a memory 56, is configured to perform frequency-multiplexing on a specific frame data. According to an original image data DATA, the memory 46 of the driving circuit 42 in the present invention generates corresponding left-eye frame data L1-Ln and right-eye frame data R1-Rn, which are then outputted to the frequency multiplexer 50 in the sequence of R1, L1, R2, L2, . . . , Rn and Ln. The frequency multiplexer 50 generates left-eye multiplexed frame data L1′-Ln′ and right-eye multiplexed frame data R1′-Rn′ by performing frequency-multiplexing on the corresponding left-eye frame data L1-Ln and the corresponding right-eye frame data R1-Rn, respectively. Therefore, the driving circuit 42 may output two identical multiplexed frame data during each of the frame periods F1-Fn.

For example, the graphic card 46 outputs the first right-eye frame data R1, which is then stored in the memory 56 of the frequency-multiplexer 50; next, the graphic card 46 outputs the first left-eye frame data L1, which is then stored in the memory 56 of the frequency-multiplexer 50. Meanwhile, the frequency multiplexer 50 performs frequency-multiplexing on the right-eye frame data R1 stored in the memory 56 and outputs two identical multiplexed right-eye frame data R1′ to the LCD panel 44 during the frame period F1; next, the graphic card 46 outputs the second right-eye frame data R2, which is then stored in the memory 56 of the frequency-multiplexer 50. Meanwhile, the frequency multiplexer 50 performs frequency-multiplexing on the left-eye frame data L1 stored in the memory 56 and outputs two identical multiplexed left-eye frame data L1′ to the LCD panel 44 during the frame period F2; the same continues for the entire image.

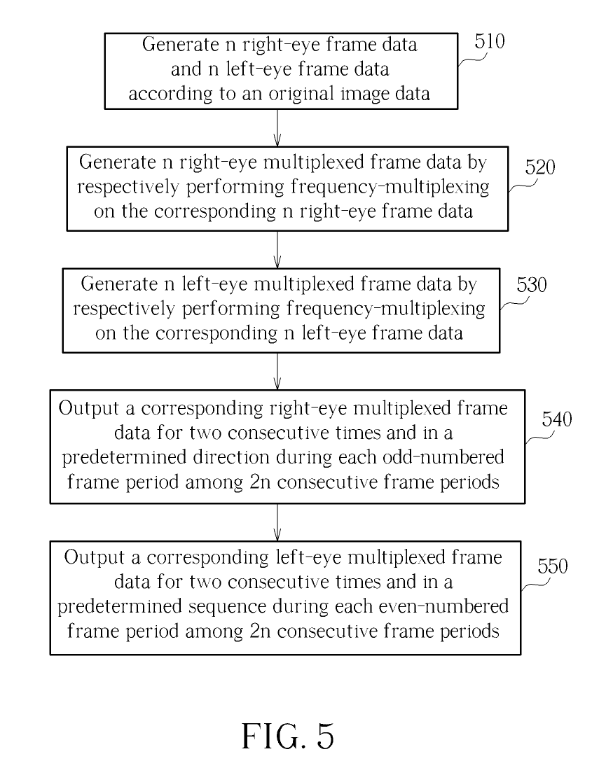

FIG. 5 is a flowchart illustrating the operation of the LCD device 40 according to the present invention. FIG. 5 includes the following steps:

Step 510: generate n right-eye frame data and n left-eye frame data according to an original image data;

Step 520: generate n right-eye multiplexed frame data by respectively performing frequency-multiplexing on the corresponding n right-eye frame data;

Step 530: generate n left-eye multiplexed frame data by respectively performing frequency-multiplexing on the corresponding n left-eye frame data;

Step 540: output a corresponding right-eye multiplexed frame data for two consecutive times and in a predetermined direction during each odd-numbered frame period among 2n consecutive frame periods; and

Step 550: output a corresponding left-eye multiplexed frame data for two consecutive times and in a predetermined sequence during each even-numbered frame period among 2n consecutive frame periods.

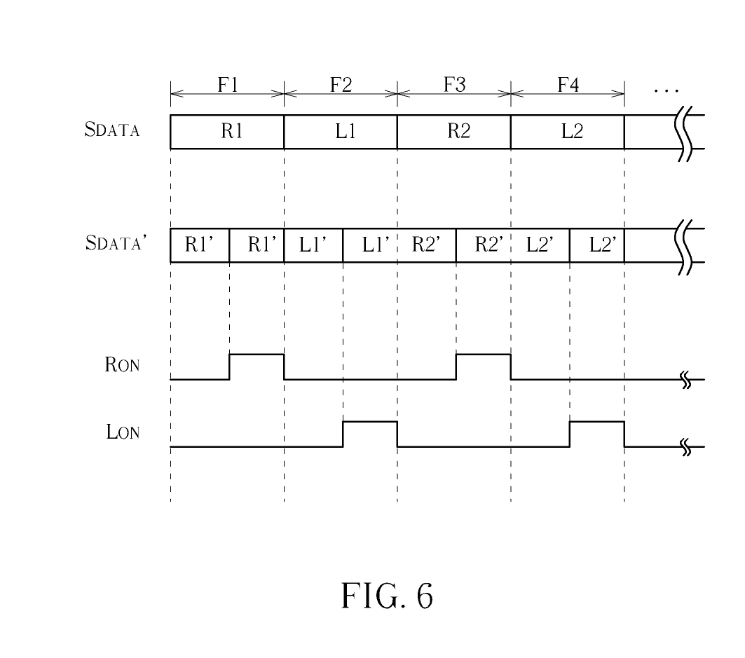

FIG. 6 is a diagram illustrating a method for driving the LCD 40 device in order to display stereoscopic images according to a first embodiment of the present invention. In FIG. 6, S_{DATA} represents the frame data received by the frequency multiplexer 50, S_{DATA}′ represents the frame data outputted by the frequency multiplexer 50, L_{ON} represents the left-eye lens-on signal, and R_{ON} represents the right-eye lens-on signal. According to the original image data DADA, the graphic card 46 of the driving circuit 42 in the present invention sequentially outputs frame data R1, L1, R2, L2, . . . , Rn to the frequency multiplexer 50, which then generates corresponding multiplexed frame data R1′, L1′, R2′, L2′, . . . , Rn′ accordingly. Therefore, two identical multiplexed frame data among the multiplexed frame data L1′-Ln′ and R1′-Rn′ can be written during the write periods in the corresponding frame data L1-Ln and R1-Rn. On the other hand, when a multiplexed frame data is written for the second time during a corresponding frame period, the present invention turns on the corresponding left-eye or the right-eye lens in an alternative manner, so that the left-eye and right-eye images may be transmitted to human brain, thereby creating stereoscopic images in human perception.

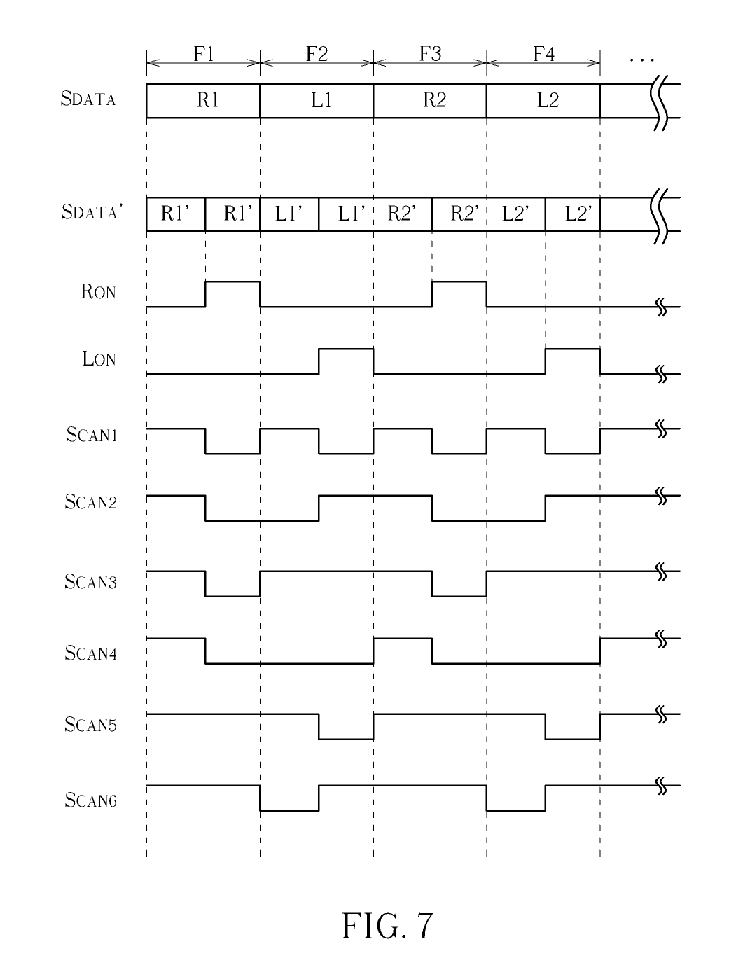

FIG. 7 is a diagram illustrating a method for driving the LCD 40 device in order to display stereoscopic images according to a second embodiment of the present invention. In FIG. 7, S_{DATA} represents the frame data received by the frequency multiplexer 50, S_{DATA}′ represents the frame data outputted by the frequency multiplexer 50, L_{ON} represents the left-eye lens-on signal, R_{ON} represents the right-eye lens-on signal, and SCAN1-SCAN6 represent the control signals associated with scan sequence. In the first embodiment of the present invention, two identical multiplexed frame data is written twice during each frame period, both times in the same direction; in the second embodiment of the present invention, two identical multiplexed frame data may written in different directions during each frame period. Assume that the multiplexed frame data is outputted in a top-to-bottom direction when the control signals SCAN1-SCAN6 are at high level, and that the multiplexed frame data is outputted in a bottom-to-top direction when the control signals SCAN1-SCAN6 are at low level. As depicted in FIG. 7, when outputting the two identical multiplexed frame data according to the control signal SCAN1, the first right-eye multiplexed frame data is scanned from top to bottom, and the second multiplexed frame data is scanned from bottom to top; when outputting the two identical multiplexed frame data according to the control signal SCAN2, the first right-eye multiplexed frame data is scanned from top to bottom, the second right-eye multiplexed frame data is scanned from bottom to top, the first left-eye multiplexed frame data is scanned from bottom to top, and the second left-eye multiplexed frame data is scanned from top to bottom; when outputting the two identical multiplexed frame data according to the control signal SCAN3, the first right-eye multiplexed frame data is scanned from top to bottom, the second right-eye multiplexed frame data is scanned from bottom to top, and the two left-eye multiplexed frame data is scanned from top to bottom; when outputting the two identical multiplexed frame data according to the control signal SCAN4, the first right-eye multiplexed frame data is scanned from top to bottom, the second right-eye multiplexed frame data is scanned from bottom to top, and the two left-eye multiplexed frame data is scanned from bottom to top; when outputting the two identical multiplexed frame data according to the control signal SCAN5, the two right-eye multiplexed frame data is scanned from top to bottom, the first left-eye multiplexed frame data is scanned from top to bottom, and the second left-eye multiplexed frame data is scanned from bottom to top; when outputting the two identical multiplexed frame data according to the control signal SCAN6, the two right-eye multiplexed frame data is scanned from top to bottom, the first left-eye multiplexed frame data is scanned from bottom to top, and the second left-eye multiplexed frame data is scanned from top to bottom. The scan sequences depicted in FIG. 7 are merely for illustration and do not limit the scope of the present invention.

As previously stated, according to the original image data DADA, the graphic card 46 of the driving circuit 42 in the present invention sequentially outputs frame data R1, L1, R2, L2, . . . , Rn to the frequency multiplexer 50, which then generates corresponding multiplexed frame data R1′, L1′, R2′, L2′, . . . , Rn′ accordingly. Therefore, two identical multiplexed frame data among the multiplexed frame data L1′-Ln′ and R1′-Rn′ can be written during the write periods in the corresponding frame data L1-Ln and R1-Rn. On the other hand, when a multiplexed frame data is written for the second time during a corresponding frame period, the present invention turns on the corresponding left-eye or the right-eye lens in an alternative manner, so that the left-eye and right-eye images may be transmitted to human brain, thereby creating stereoscopic images in human perception.

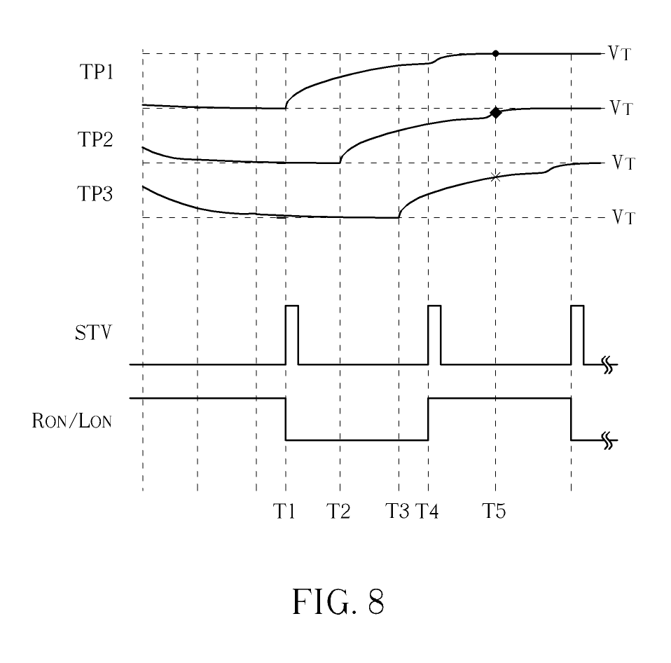

FIG. 8 is a diagram illustrating the operation of the present LCD device 40 when displaying stereoscopic images. If the LCD device 40 is scanned in a top-to-bottom direction, TP1, TP2 and TP3 represent the pixel voltages at the test points which are located in upper, central and lower parts of the LCD panel, respectively. L_{ON}/R_{ON} represents the left-eye lens-on signal or the right-eye lens-on signal. During the vertical blanking intervals when the left-eye lens or the right-eye lens is turned on, the levels of the corresponding pixel voltages TP1, TP2 and TP3 are indicated by “”, “♦” and “X” in FIG. 8. As shown in FIG. 8, after being triggered by the start pulse voltage STV at T1, data is first written into the pixels located in the upper part of the LCD panel at T1, then into the pixels located in the central part of the LCD panel at T2, and then into the pixels located in the lower part of the LCD panel at T3. When scanned from top to bottom, the pixels located in the lower part of the LCD panel have the shortest reaction time. In the present invention, the same multiplexed frame data is written for two consecutive times so that the pixels can have sufficient charge time for reaching the target level. As shown in FIG. 8, the differences between the pixel voltages TP1-TP3 and the target voltage V_{T} at T5 can be reduced after the left-eye lens or the right-eye lens is turned on at T4, thereby providing better optical uniformity. In top-to-bottom, bottom-to-top and other scan directions, the present invention can increase the charge time for the pixels which are located at the remotest part of the LCD panel with respect to the start point of data scan. FIG. 8 is only for illustration and does not limit the scope of the present invention.

Those skilled in the art will readily observe that numerous modifications and alterations of the device and method may be made while retaining the teachings of the invention.

What is claimed is:

1. A method for displaying stereoscopic images comprising:
generating a plurality of right-eye frame data and a plurality of left-eye frame data according to an original image data;
generating a first right-eye multiplexed frame data by performing frequency-multiplexing on a first right-eye frame data among the plurality of right-eye frame data;
generating a first left-eye multiplexed frame data by performing frequency-multiplexing on a first left-eye frame data among the plurality of left-eye frame data;
outputting the first right-eye multiplexed frame data for two consecutive times during a first frame period; and
outputting the first left-eye multiplexed frame data for two consecutive times during a second frame period subsequent to the first frame period.

2. The method for displaying stereoscopic images as claim 1 further comprising:
storing the first right-eye frame data;
receiving the first left-eye frame data after storing the first right-eye frame data; and
storing the first left-eye frame data and performing frequency-multiplexing on the first right-eye frame data after receiving the first left-eye frame data.

3. The method for displaying stereoscopic images as claim 1 further comprising:
outputting the first right-eye multiplexed frame data in a first scan direction for a first time during the first frame period; and
outputting the first right-eye multiplexed frame data in a second scan direction for a second time during the first frame period, wherein the first and second directions are opposite directions.

4. The method for displaying stereoscopic images as claim 3 further comprising:
outputting the first left-eye multiplexed frame data in the first scan direction for a first time during the second frame period; and
outputting the first left-eye multiplexed frame data in the second scan direction for a second time during the second frame period.

5. The method for displaying stereoscopic images as claim 3 further comprising:
outputting the first left-eye multiplexed frame data in the second scan direction for a first time during the second frame period; and
outputting the first left-eye multiplexed frame data in the first scan direction for a second time during the second frame period.

6. The method for displaying stereoscopic images as claim 3 further comprising:
outputting the first left-eye multiplexed frame data in the first scan direction for two consecutive times during the second frame period.

7. The method for displaying stereoscopic images as claim 3 further comprising:
outputting the first left-eye multiplexed frame data in the second scan direction for two consecutive times during the second frame period.

8. The method for displaying stereoscopic images as claim 1 further comprising:
outputting the first right-eye multiplexed frame data in a first scan direction for two consecutive times during the first frame period.

9. The method for displaying stereoscopic images as claim 8 further comprising:
outputting the first left-eye multiplexed frame data in a second scan direction for two consecutive times during the second frame period, wherein the first and second directions are opposite directions.

10. The method for displaying stereoscopic images as claim 8 further comprising:
outputting the first left-eye multiplexed frame data in the first scan direction for a first time during the second frame period; and
outputting the first left-eye multiplexed frame data in a second scan direction for a second time during the second frame period, wherein the first and second directions are opposite directions.

11. The method for displaying stereoscopic images as claim 8 further comprising:
outputting the first left-eye multiplexed frame data in a second scan direction for a first time during the second frame period; and
outputting the first left-eye multiplexed frame data in the first scan direction for a second time during the second frame period, wherein the first and second directions are opposite directions.

12. The method for displaying stereoscopic images as claim 1 further comprising:
outputting the first right-eye multiplexed frame data in a predetermined scan direction for two consecutive times during the first frame period; and
outputting the first left-eye multiplexed frame data in the predetermined scan direction for two consecutive times during the second frame period.

13. The method for displaying stereoscopic images as claim 1 further comprising:
generating a second right-eye multiplexed frame data by performing frequency-multiplexing on a second right-eye frame data among the plurality of right-eye frame data;
generating a second left-eye multiplexed frame data by performing frequency-multiplexing on a second left-eye frame data among the plurality of left-eye frame data;
outputting the second right-eye multiplexed frame data for two consecutive times during a third frame period subsequent to the second frame period; and
outputting the second left-eye multiplexed frame data for two consecutive times during a fourth frame period subsequent to the third frame period.

14. The method for displaying stereoscopic images as claim 13 further comprising:
receiving the second right-eye frame data after storing the second left-eye frame data; and
storing the second right-eye frame data and performing frequency-multiplexing on the first left-eye frame data after receiving the second right-eye frame data.
